(19) United States
(12) Patent Application Publication
(10) Pub. No.: US 2009/0100740 A1
(43) Pub. Date: Apr. 23, 2009

(54) TRIANGULAR SHAPED CEDAR PLUG FISHING LURE AND METHOD

(75) Inventor: KWOK KONG CHAN, Albany, NY (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: River2Sea, LLC, Richmond, CA (US)

(21) Appl. No.: 11/876,992

(22) Filed: Oct. 23, 2007

(51) Int. Cl. A01K 85/00

(52) U.S. Cl. 43/42.48; 43/42.36; 43/42.39

(57) ABSTRACT

A fishing lure device. The device has a weighted head member configured as a fish head. In a specific embodiment, the weighted head member comprises primarily of a metal material. The weighted head member has a first end forming an apex extending to a second end. In a specific embodiment, the device has an elongated body member attached to the weighted head member at the second end. The elongated body member comprising a shaped wood material, which is buoyant. In a specific embodiment, the elongated body member extends from the second end to a tail end. The device also has a triangular cross-section characterizing a portion of the elongated body member. The triangular cross-section comprises a first side region, a second side region, and a base region. In a specific embodiment, the base region is a bottom portion of the elongated body member. In a specific embodiment, the first side region and the second side region respectively extend from the base region and coupled at an upper apex region, which is a top portion of the elongated body member. In a specific embodiment, the lure device has an interior channel extending longitudinally from the first end of the apex of the weighted head member to the second end of the weighted head member and to the tail end of the elongated member. The interior channel has a front opening and a back opening configured for a fishing line there through. In a specific embodiment, the weighted head member has a top portion and a bottom portion, which is characterized by a higher mass than a mass of the top portion.

### CROSS-REFERENCES TO RELATED APPLICATIONS

Not Applicable

### STATEMENT AS TO RIGHTS TO INVENTIONS MADE UNDER FEDERALLY SPONSORED RESEARCH OR DEVELOPMENT

Not Applicable

### REFERENCE TO A “SEQUENCE LISTING,” A TABLE, OR A COMPUTER PROGRAM LISTING APPENDIX SUBMITTED ON A COMPACT DISK

Not Applicable

### BACKGROUND OF THE INVENTION

The present invention relates generally to fishing techniques and in particular fishing lures. More particularly, the invention provides a triangular shaped cedar plug fishing lure and method according to a specific embodiment. Merely by way of example, the invention has been applied to a wooden cedar plug fishing lure, but it would be recognized that other applications exist.

One of the greatest sporting activities known to mankind is fishing. Human beings involved in the activity of fishing are often called “fisherman” or “fisherwoman.” Fishing often involves using a bait, whether natural or artificial, which is coupled to one or more hooks that are tied to a line attached to a fishing rod and reel. The bait is introduced into a lake, stream, or ocean to attract and lure a fish to strike it. Once the fish strikes, sharp hooks coupled to the bait pierce into the tissue of the fish. Oftentimes, the fish becomes hooked in the mouth. After a struggle between the fisherman and the fish, one of them wins. Either the fisherman happily lands the fish or the fish breaks itself from the hook and swims away.

In sport fishing, artificial bait is often called a lure, which is an object attached to the end of the fishing line and designed to resemble and move like an item of fish prey. See, http://en.wikipedia.org. Often times, the lure is equipped with one or more hooks that hold the fish attracted to the lure. An example of a fishing lure for tuna fishing and the like is a cedar plug. The cedar plug often includes a body carved out of cedar wood, which is annular in shape, and has a weighted head. The plug has an opening that allows for line to traverse through the body and attach to a single large hook. When moved through the water, the plug often traverses through the water in a random manner. Although highly successful, the cedar plug has limitations.

From the above, it is seen that improved techniques for lure designs are highly desired.

### BRIEF SUMMARY OF THE INVENTION

According to the present invention, techniques for fishing are included. More particularly, the invention provides a triangular shaped cedar plug fishing lure and method according to a specific embodiment. Merely by way of example, the invention has been applied to a wooden cedar plug fishing lure, but it would be recognized that other applications exist.

In a specific embodiment, the present invention provides a trolling plug with angular sides and a specially weighted bottom designed to keep the plug stable as it imitates a frantic action of a wounded baitfish. The present plug is designed for trolling at slow or high speeds and erratically darts while trolled just under the surface for any or all sorts of saltwater schooling fish such as tuna, wahoo, and other saltwater species. In a preferred embodiment, the fishing line runs through a sleeve in the body and ties to a long shank hook (e.g., Mustad 3412 long shank hook). In one or more embodiments, the plug can be provided in different sizes and finishes. Of course, there can be other variations, modifications, and alternatives.

In a specific embodiment, the present invention provides a fishing lure device. The device has a weighted head member configured as a fish head. In a specific embodiment, the weighted head member comprises primarily of a metal material, e.g., lead, iron, steel, tungsten. The weighted head member has a first end forming an apex extending to a second end. In a specific embodiment, the device has an elongated body member attached to the weighted head member at the second end. The elongated body member comprising a shaped wood material, which is buoyant. In a specific embodiment, the elongated body member extends from the second end to a tail end. The device also has a triangular cross-section characterizing a portion of the elongated body member. The triangular cross-section comprises a first side region, a second side region, and a base region. In a specific embodiment, the base region is a bottom portion of the elongated body member. In a specific embodiment, the first side region and the second side region respectively extend from the base region and coupled at an upper apex region, which is a top portion of the elongated body member. In a specific embodiment, the lure device has an interior channel extending longitudinally from the first end of the apex of the weighted head member to the second end of the weighted head member and to the tail end of the elongated member. The interior channel has a front opening and a back opening configured for a fishing line there through. In one or more embodiments, a first eye spatially positioned on a first portion of the weighted head member and a second eye spatially positioned on a second portion of the weighted head member.

In an alternative specific embodiment, the present invention provides an alternative fishing lure device. The device has a weighted head member configured as a fish head. In a specific embodiment, the weighted head member comprises primarily of a metal material. The weighted head member has a first end forming an apex extending to a second end. In a specific embodiment, the device has an elongated body member attached to the weighted head member at the second end. The elongated body member comprising a shaped wood material, which is buoyant. In a specific embodiment, the elongated body member extends from the second end to a tail end. The device also has a triangular cross-section characterizing a portion of the elongated body member. The triangular cross-section comprises a first side region, a second side region, and a base region. In a specific embodiment, the base region is a bottom portion of the elongated body member. In a specific embodiment, the first side region and the second side region respectively extend from the base region and coupled at an upper apex region, which is a top portion of the elongated body member. In a specific embodiment, the lure device has an interior channel extending longitudinally from the first end of the apex of the weighted head member to the second end of the weighted head member and to the tail end of the elongated member. The interior channel has a front opening and a back opening configured for a fishing line there through. In a specific embodiment, the weighted head member has a top portion and a bottom portion, which is characterized by a higher mass than a mass of the top portion. In a specific embodiment, the higher mass causes the fishing lure device to be characterized as having a center of gravity within a vicinity of the bottom portion of the weighted head member to maintain the fishing lure device in an upright position when moved through a body of water. The weighted head also assists the lure device to have a diving action relative to the elongated body member according to a specific embodiment.

Still further, the present invention provides an alternative fishing lure device. The device has a head member in the general shape of a fish head, which is a metal material. The device has a cavity in a rear portion of the head member. An elongated body member made of wood is attached to the head member. A projection in a front portion of the body member is included. The projection configured for insertion into the cavity for attaching the body member to the head member. An interior channel extends longitudinally through the head member and body member. The channel has a front opening and a back opening configured for a fishing line. A weighted element is integrally built in at least on a bottom portion of the head member a weight the lure to weigh the head member in an upright direction. In a specific embodiment, a triangular cross section characterizes a portion of the body member. The triangular cross section includes two side surfaces and a bottom surface, a rounded top connecting the two side surfaces, and two rounded bottom corners connecting the bottom surface to the two side surfaces, respectively.

In an alternative embodiment, the present invention provides a method for manufacturing a cedar plug lure. The method includes providing a head member in the general shape of a fish head. The head member is made of a metal is configured with a cavity in a rear portion of the head member. In a preferred embodiment, the head member is configured as an integral weight element having a heavier bottom portion relative to an upper portion of the head member. The method includes coupling an elongated body member to the head member such that a projection in a front portion of the body member is inserted into the cavity. Depending upon the embodiment, the body member can be made of wood and has an interior channel extending longitudinally through the head member and body member. The channel has a front opening and a back opening for receiving a fishing line. The elongated body member has a triangular cross section characterizing a portion of the body member, two side surfaces, a bottom surface, a rounded top connecting the two side surfaces, and two rounded bottom corners connecting the bottom surface to the two side surfaces, respectively.

One or more benefits can be achieved using the present invention over conventional techniques. The present invention can be made using conventional materials and components according to a specific embodiment. Additionally, the invention can be applied to cedar plug lures and other like lures. In a preferred embodiment, the present invention provides a cedar plug lure having a triangular body shape and weighted belly portion to allow the lure to dive and traverse through a body of water without rotating to imitate a wounded bait, e.g., fish, squid. In a preferred embodiment, the present cedar lure device darts through a body of water, dives, and is substantially free from rotation, which can lead to line twist and other problems. These and other benefits have been described throughout the present specification and more particularly below.

Various additional objects, features and advantages of the present invention can be more fully appreciated with reference to the detailed description and accompanying drawings that follow.

### BRIEF DESCRIPTION OF THE DRAWINGS

FIG. 1 is a simplified side-view diagram of a cedar plug lure according to an embodiment of the present invention;

FIG. 2 is a simplified top-view diagram of a cedar plug lure according to an embodiment of the present invention;

FIG. 3 is a perspective diagram of a cedar plug lure according to an embodiment of the present invention;

FIG. 4 is a tail-view diagram of a cedar plug lure according to an embodiment of the present invention;

FIG. 5 is a top-view diagram of a cedar plug lure according to an embodiment of the present invention;

FIG. 6 is a head-view diagram of a cedar plug lure according to an embodiment of the present invention;

FIG. 7 illustrates multiple views of assembling the cedar plug lure according to an embodiment of the present invention;

FIG. 8 is a simplified side-view diagram of a weighted head according to an embodiment of the present invention; and

FIG. 9 is a simplified back-view diagram of a cedar plug lure according to an embodiment of the present invention.

### DETAILED DESCRIPTION OF THE SPECIFIC EMBODIMENTS

According to the present invention, techniques for fishing are included. More particularly, the invention provides a triangular shaped cedar plug fishing lure and method according to a specific embodiment. Merely by way of example, the invention has been applied to a wooden cedar plug fishing lure, which moves in a darting manner, but it would be recognized that other applications exist.

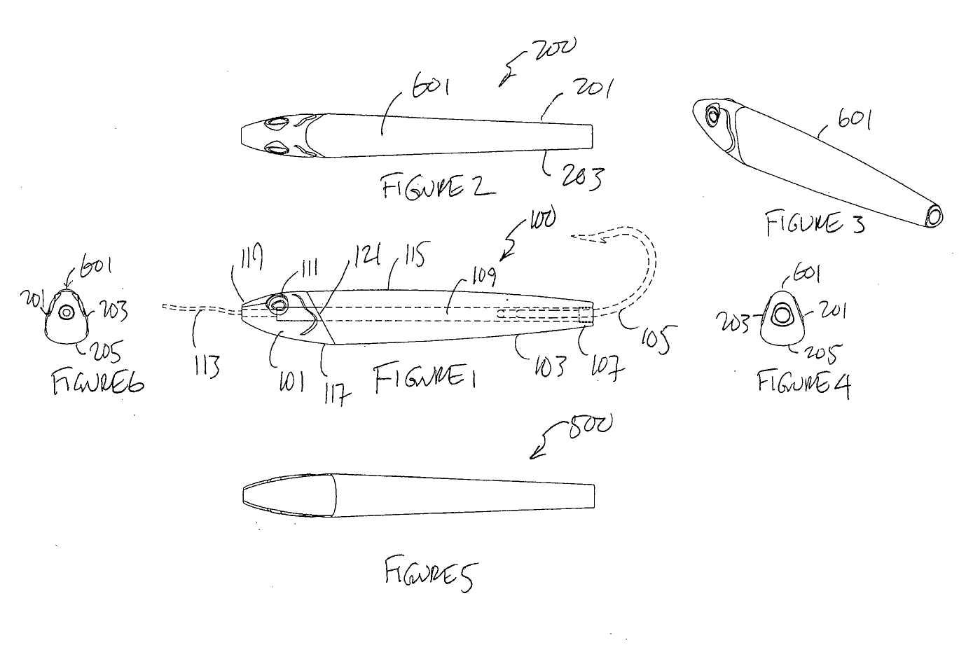

FIG. 1 is a simplified side-view diagram of a cedar plug lure 100 according to an embodiment of the present invention. This diagram is merely an example, which should not unduly limit the scope of the claims herein. One of ordinary skill in the art would recognize other variations, modifications, and alternatives. As shown, the present invention provides a fishing lure device 100. The device has a weighted head member 101 configured as a fish head or other bait head. In a specific embodiment, the weighted head member comprises primarily of a metal material. In a specific embodiment, the metal material can be selected from any suitable material with sufficient mass such as lead, tungsten, iron, brass, steel, any combination of these, and alloys, and the like. In a specific embodiment, the weighted head member has a top portion 111 and a bottom portion 117, which is characterized by a higher mass than a mass of the top portion. In a specific embodiment, the higher mass causes the fishing lure device to be characterized as having a center of gravity within a vicinity of the bottom portion of the weighted head member to maintain the fishing lure device in an upright position when moved through a body of water. In a preferred embodiment, the weight of the bottom portion relative to a center line point 109 is about ten percent greater than the top portion of the weighted head. Of course, there can be other variations, modifications, and alternatives.

In a specific embodiment, the weighted head member has a first end forming an apex 119 extending to a second end 121. In one or more embodiments, the apex can be rounded or have a sharp point depending upon the application. As shown, the second end is shaped to cause a longer bottom portion relative to the top portion for the lower center of mass. In one or more embodiments, a first eye spatially positioned on a first portion of the weighted head member and a second eye spatially positioned on a second portion of the weighted head member. In other embodiments, there can be no eyes or only a single eye, which may be disposed on other portions of the weighted head member or elongated member. Of course, there can be other variations, modifications, and alternatives.

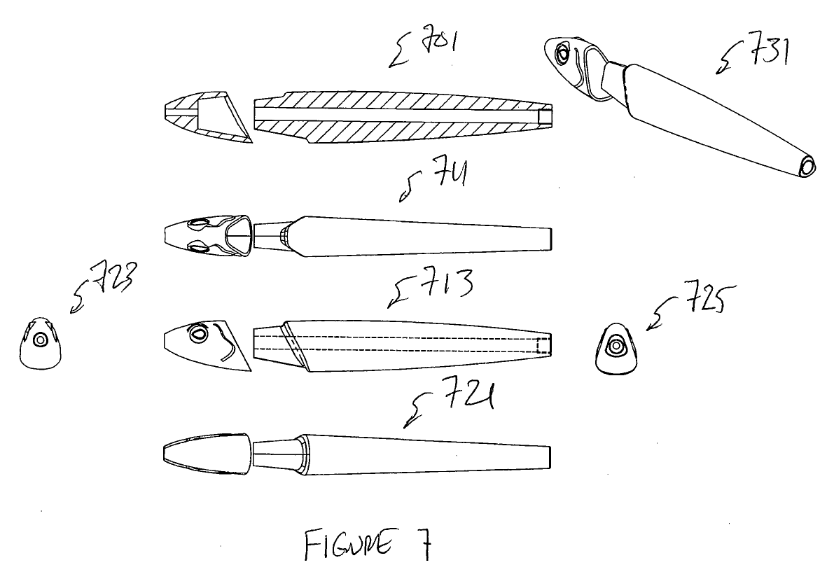

In a specific embodiment, the device has an elongated body member 103 attached to the weighted head member at the second end 121. The elongated body member comprising a shaped wood material, which is buoyant. In a preferred embodiment, the wood is a high grade cedar material. Alternatively, the wood can be any suitable wood and/or plastic including a foam or other combination of materials, including composites that have a buoyant characteristic. In a specific embodiment, the elongated body member extends from the second end to a tail end 107. The device also has a triangular cross-section characterizing a portion of the elongated body member. In a specific embodiment, the weighted head member is integral with the elongated body to form a continuous member, which may include a single or multiple materials. Further details of the cedar plug lure is provided throughout the present specification and more particularly to the Figures below. As an example, FIG. 2 is a simplified top-view diagram 200 of a cedar plug lure according to an embodiment of the present invention. FIG. 3 is a perspective diagram of a cedar plug lure according to an embodiment of the present invention. FIG. 4 is a tail-view diagram of a cedar plug lure according to an embodiment of the present invention. FIG. 5 is a bottom-view diagram 500 of a cedar plug lure according to an embodiment of the present invention. FIG. 6 is a head-view diagram of a cedar plug lure according to an embodiment of the present invention.

Referring back to FIGS. 2 through 6, the triangular cross-section comprises a first side region 201, a second side region 203, and a base region 205. The triangular cross-section can include rounded or sharp corners that define apexes. In a specific embodiment, the base region is a bottom portion of the elongated body member. That is, the bottom portion is a belly of the plug lure. In a specific embodiment, the first side region and the second side region respectively extend from the base region and coupled at an upper apex region 601, which is a top portion of the elongated body member. In a specific embodiment, the upper apex region is rounded and has a radius of curvature and lower base regions also have radius of curvatures that are configured to maintain the plug lure in an upright position while being pulled through the water without rolling and/or causing any twist to the fishing line. Of course, there can be other variations, modifications, and alternatives.

In a specific embodiment referring back to FIG. 1, the lure device has an interior channel 109 extending longitudinally from the first end of the apex of the weighted head member to the second end of the weighted head member and to the tail end of the elongated member. The interior channel has a front opening and a back opening configured for a fishing line 113 there through. In one or more embodiments, a first eye spatially positioned on a first portion of the weighted head member and a second eye spatially positioned on a second portion of the weighted head member. In other embodiments, there can be no eyes or only a single eye, which may be disposed on other portions of the weighted head member or elongated member. Of course, there can be other variations, modifications, and alternatives.

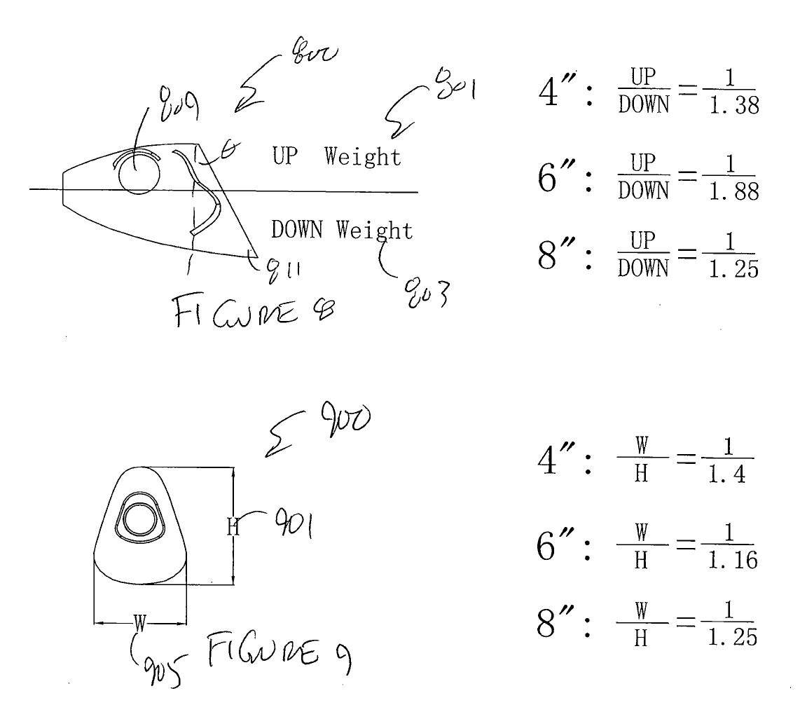

FIG. 7 illustrates multiple views of assembling the cedar plug lure according to an embodiment of the present invention. This diagram is merely an example, which should not unduly limit the scope of the claims herein. One of ordinary skilled in the art would recognize other variations, modifications, and alternatives. As shown, the plug lure is illustrated in a side-view cross-section 701, top view 711, side-view 713, bottom-view 721, and perspective view 731. Other views include front view 723 and back-view 725.

In a specific embodiment, the weighted head includes a cavity region, which forms a mortise structure, which is coupled to an elongated region, which has a smaller exterior periphery than an outer periphery of the elongated member. The elongated region with the smaller exterior periphery forms a tenon structure. The tenon structure couples to the mortise structure using a glue or other attachment material to firmly engage the weighted head to the elongated member. In a specific embodiment, the elongated member is carved from a wood material such as cedar or other suitable material, which is buoyant in characteristic such as foam, sponge, plastic, or the like. Any combinations of these materials can also be used depending upon the specific embodiment. In a specific embodiment, the tenon structure couples to the mortise structure with a suitable glue material such as an epoxy or other non-water soluble glue material. Of course, there can be other variations, modifications, and alternatives.

FIG. 8 is a simplified side-view diagram of a weighted head 800 according to an embodiment of the present invention. As shown, the weighted head can be defined by an upper portion 801 and a lower portion 803 as illustrated by the line, which is horizontal and intersects these two portions. In a specific embodiment, the lower portion is made with a protruded region, which extends beyond the upper portion to form a triangular region as defined by angle theta. As shown, the lower portion, which is made of the same material as the upper portion, is larger and is therefore heavier than the upper portion. Depending upon the embodiment, various weight ratios can be provided, although these are merely examples.
Four Inch Plug UP/DOWN=1/1.38
Six Inch Plug UP/DOWN=1/1.88
Eight Inch Plug UP/DOWN=1/1.25
   Of course, there can be various modifications, alternatives, and variations.

FIG. 9 is a simplified back-view diagram of a cedar plug lure 900 according to an embodiment of the present invention. As shown, the plug has a height 901 and width 905, which serves as the belly region. In a specific embodiment, the width and height are configured to allow the plug lure to traverse through the water without rolling and twisting the fishing line. In a specific embodiment, the plug lure can be pulled through the water at a high speed such as 12 knots or even 14 knots without rotating about the line and twisting it. As shown, various height/width ratios can be provided, although these are merely examples.
Four Inch Plug W/H=1/1.4
Six Inch Plug W/H=1/1.16
Eight Inch Plug W/H=1/1.25

Of course, there can be various modifications, alternatives, and variations.

It is also understood that the examples and embodiments described herein are for illustrative purposes only and that various modifications or changes in light thereof will be suggested to persons skilled in the art and are to be included within the spirit and purview of this application and scope of the appended claims. As an example, the elongated body can be continuous with the weighted head and be made of similar materials according to a specific embodiment. Other than wood, the elongated body can be made of plastic, foam plastic, or other suitable materials capable of having a buoyant effect according to an embodiment.

What is claimed is:

1. A fishing lure device, comprising:
a weighted head member configured as a fish head, the weighted head member comprising primarily of a metal material, the weighted head member having a first end forming an apex extending to a second end;
an elongated body member attached to the weighted head member at the second end, the elongated body member comprising a shaped wood material, the elongated body member extending from the second end to a tail end;
a triangular cross-section characterizing a portion of the elongated body member, the triangular cross-section comprises a first side region, a second side region, and a base region, the base region being a bottom portion of the elongated body member, the first side region and the second side region respectively extending from the base region and coupled at an upper apex region, the upper apex region being a top portion of the elongated body member;
an interior channel extending longitudinally from the first end of the apex of the weighted head member to the second end of the weighted head member and to the tail end of the elongated member, the interior channel having a front opening and a back opening configured for a fishing line there through;
a first eye spatially positioned on a first portion of the weighted head member; and
a second eye spatially positioned on a second portion of the weighted head member.

2. The device of claim 1 wherein the weighted head member is configured relative to the elongated body member to cause the weighted head member to dive relative to the elongated body member that is buoyant in characteristic, the elongated body member being comprised of a cedar wood material or a plastic material.

3. The device of claim 1 wherein the portion extends from the second end to the tail end of the elongated body member.

4. The device of claim 1 wherein the triangular cross-section is configured to cause the fishing lure device to be substantially free from rotation about the interior channel upon moving the fishing lure device through a body of water.

5. The device of claim 1 further comprising a fishing hook having a long shank, the long shank being provided within a portion of the interior channel while a point of the fishing hook extends outside of the tail end of the elongated body member.

6. The device of claim 1 further comprising a tenon and mortise structure coupled between the weighted head member and the elongated body member.

7. The device of claim 1 further comprising a glue material coupling the weighted head member to the elongated body member.

8. The device of claim 1 further comprising a center of gravity within a vicinity of a region of the bottom portion within a vicinity of the second end of the head member.

9. The device of claim 1 wherein the weighted head member comprises a cavity region to form a mortise structure and the elongated body member comprises a tenon structure, the tenon structure being coupled to the mortise structure to join the weighted head member to the elongated body member.

10. The device of claim 1 wherein the weighted head member comprising a top portion and a bottom portion, the bottom portion being of a higher mass than a mass of the top portion, the higher mass causing the fishing lure device to be characterized as having a center of gravity within a vicinity of the bottom portion of the weighted head member to maintain the fishing lure device in an upright position when moved through a body of water.

11. A fishing lure device, comprising:
a weighted head member configured as a fish head, the weighted head member comprising primarily of a metal material, the weighted head member having a first end forming an apex extending to a second end, the weighted head member comprising a top portion and a bottom portion, the bottom portion being of a higher mass than a mass of the top portion, the higher mass causing the fishing lure device to be characterized as having a center of gravity within a vicinity of the bottom portion of the weighted head member to maintain the fishing lure device in an upright position when moved through a body of water;
an elongated body member attached or integral to the weighted head member at the second end, the elongated body member comprising a shaped material, the elongated body member extending from the second end to a tail end;
a triangular cross-section characterizing a portion of the elongated body member, the triangular cross-section comprises a first side region, a second side region, and a base region, the base region being a bottom portion of the elongated body member, the first side region and the second side region respectively extending from the base region and coupled at an upper apex region, the upper apex region being a top portion of the elongated body member; and
an interior channel extending longitudinally from the first end of the apex of the weighted head member to the second end of the weighted head member and to the tail end of the elongated member.

12. The device of claim 1 wherein the weighted head member is configured relative to the elongated body member to cause the weighted head member to dive relative to the elongated body member that is buoyant in characteristic.

13. The device of claim 1 wherein the portion extends from the second end to the tail end of the elongated body member.

14. The device of claim 1 wherein the triangular cross-section is configured to cause the fishing lure device to be substantially free from rotation about the interior channel upon moving the fishing lure device through a body of water in a darting manner.

15. The device of claim 1 further comprising a fishing hook having a long shank, the long shank being provided within a portion of the interior channel while a point of the fishing hook extends outside of the tail end of the elongated body member; and a line eyelet coupled to the fishing hook, the line eyelet being capable of being attached to a fishing line.

16. The device of claim 1 further comprising a tenon and mortise structure coupled between the weighted head member and the elongated body member.

17. The device of claim 1 further comprising a glue material coupling the weighted head member to the elongated body member.

18. The device of claim 1 further comprising a center of gravity within a vicinity of a region of the bottom portion within a vicinity of the second end of the head member.

19. The device of claim 1 wherein the weighted head member comprises a cavity region to form a mortise structure and the elongated body member comprises a tenon structure, the tenon structure being coupled to the mortise structure to join the weighted head member to the elongated body member.

20. A fishing lure, comprising:
a head member in the general shape of a fish head, the head member being made of a metal;
a cavity in a rear portion of the head member;
an elongated body member attached to the head member, the body member being made of wood;
a projection in a front portion of the body member, the projection being configured for insertion into the cavity for attaching the body member to the head member;
an interior channel extending longitudinally through the head member and body member, the channel having a front opening and a back opening for receiving a fishing line there through; and
a weight element integrally built in at least on a bottom portion of the head member a weight the lure;
a triangular cross section characterizing a portion of the body member, the triangular cross section including two side surfaces and a bottom surface, a rounded top connecting the two side surfaces, and two rounded bottom corners connecting the bottom surface to the two side surfaces, respectively.

21. A method for manufacturing a cedar plug lure, the method comprising:
providing a head member in the general shape of a fish head, the head member being made of a metal, the head member configured with a cavity in a rear portion of the head member, the head member being configured as an integral weight element having a heavier bottom portion relative to an upper portion of the head member; and
coupling an elongated body member to the head member such that a projection in a front portion of the body member is inserted into the cavity, the body member being made of wood, the elongated body including an interior channel extending longitudinally through the head member and body member, the channel having a front opening and a back opening for receiving a fishing line, the elongated body member having a triangular cross section characterizing a portion of the body member, the triangular cross section including two side surfaces and a bottom surface, a rounded top connecting the two side surfaces, and two rounded bottom corners connecting the bottom surface to the two side surfaces, respectively.
